(19) United States
(12) Patent Application Publication
(10) Pub. No.: US 2003/0175656 A1
(43) Pub. Date: Sep. 18, 2003

(54) Hydrogel incorporated with bone growth promoting agents for dental and oral surgery

(76) Inventors: Erella Livne, Haifa (IL); Samer Srouji, Nazareth (IL)

Correspondence Address: Anthony Castorina, G E Ehrlich (1995) Ltd, Suite 207, 2001 Jefferson Davis Highway, Arlington, VA, 22202, US

(21) Appl. No.: 10/344,942

(22) PCT Filed: Sep. 5, 2001
(86) PCT No.: PCT/IL01/00835

(30) Foreign Application Priority Data
Sep. 5, 2000 (US) 60229813
Nov. 16, 2000 (US) 09713037

(51) Int. Cl. A61C 8/00; A61C 5/00

(52) U.S. Cl. 433/201.1; 433/217.1

(57) ABSTRACT

A dental implant that comprises a generally rod-like article formed with one or more hollow(s) therein and a biodegradable hydrogel containing one or more bone growth-promoting agent(s) in the hollow(s) is disclosed. A method of implanting the dental implant and a method of sinus augmentation prior to implanting a dental implant are further disclosed.

### FIELD AND BACKGROUND OF THE INVENTION

The present invention relates, in general, to dental and oral surgeries and, more particularly, to (i) a dental implant that comprises a hollow including a biodegradable, three-dimensional (3-D) hydrogel containing one or more bone growth-promoting agent(s) for promoting osteoinduction and osteoconduction and/or osteoprogenitor cells hence resulting in osteointegration; (ii) a method for sinus bone augmentation prior to a dental implantation procedure; (iii) a method for oral prosthetic rehabilitation; and (iv) a method of repairing a bone defect in the oral cavity.

Successful use of implantable material for oral prosthetic rehabilitation has multiple requirements. Successful healing following implantation of a prosthesis of foreign material is one of the important requirements, and it is the foundation necessary for overall success of a prosthesis.

During the past two decades, endosseous implants have been used extensively to achieve osteointegration for prosthetic rehabilitation of adentulism. Since the mid 1970s, the general consensus for successful implant healing is the formation of a direct bond of implant to bone i.e., osteointegration. Osteointegration of the implant to bone is believed to be the most stable situation, and it is the healing goal of most clinical implant systems available on the market today.

There are many requirements for successful osteointegration that must be considered during the placement of an endosseous implant:

After the surgical placement of an implant into endosteal location, the traumatized bone around the implant begins a process of wound healing. When bone healing is analyzed, it can be broken down into three phases: the inflammatory phase, the proliferation phase and the maturation phase.

The inflammatory phase (days 1-10 post implantation): The placement of implants into bone generates a thin layer of necrotic bone in the pre-implant region. When the implant is exposed to the surgical site, it comes into a contact with extracellular fluid and cells. This initial exposure of the implant to the local environment results in rapid adsorption of local plasma proteins onto the implant's surface. Platelets contacted with synthetic surfaces cause platelet activation and liberation of intracellular granules. Blood contacted with proteins and foreign material leads to the initiation of a clotting cascade via intrinsic and extrinsic pathways. During this initial implant-host interaction, numerous cytokines and growth factors are released from local cellular elements. These factors have numerous functions, including regulation of adhesion molecule production, altering cellular proliferation, increasing vascularization, enhancing collagen synthesis, regulating bone metabolism and altering migration of cells into given area.

The next events include a cellular inflammatory response. Initially, the response is non-specific in nature and consists mainly of neutrophil emigration into the area of damaged tissue, the role of this cell is primarily phagocytosis and digestion of debris and damaged tissue.

The Proliferative phase (days 3-42 post implantation): Shortly after the implant is inserted into the bone, the proliferative phase of implant healing is initiated. During this phase, vascular ingrowth occurs from surrounding vital tissues, a process of neovascularization, in addition, cellular proliferation, differentiation and activation processes take place during this phase, resulting in production of an immature connective tissue matrix.

Wound neovascularization begins as early as the third postoperative day.

The hypoxic state near the wound edges, combined with certain growth factors, such as platelet derived growth factor (PDGF), are responsible for stimulating angiogenesis.

Local mesenchymal cells begin to differentiate into fibroblasts, osteoblasts, and chondrocytes in response to hypoxia and growth factors are released from platelets, macrophages and other cellular elements. These cells begin to lay an extracellular matrix (ECM). The initial fibrous tissue and ground substance that are laid eventually form into a fibrocartilaginous callus, and this callus transforms into bone callus in a process similar to endochondral ossification.

Maturation phase (begins about 28 days post-implantation): The necrotic bone in the pre-implant space that resulted from operative trauma is eventually replaced with intact living bone. Appositional woven bone is laid on the scaffold of dead bone trabecules by differentiated mesenchymal cells in the advancing granulation tissue mass. This process occurs concurrently with ossification of the fibrocartilaginous callus. Simultaneous reposition of these trabeculae and the newly formed bone callus results in complete bone remodeling, leaving a zone of living lamellar bone that is continuous with the surrounding basal bone.

Traditional placement of endosseous implants involves a two-stage surgical procedure in which the implant is placed during the first stage and then allowed a healing period of 3 months in the lower jaw, and 6 months in the upper jaw before the transmucosal portion (loading) is placed.

To improve and accelerate osteointegration of dental implants in both mandible and maxilla and to allow early loading of the implant, it is necessary to induce osteogenic response in the healing tissue.

Bone availability is a major key for successful oral surgery including successful placement of endosseous implant and periodontal surgery. Sinus augmentation in the posterior maxilla is critical for successful implantology in the posterior maxilla. Enhanced osteointegration of implants in bone type III and IV is also critical for successful implant early loading.

The use of dental implants in oral rehabilitation has become a standard of care in dentistry. Unfortunately, replacement of missing teeth with implants in the posterior maxilla remains one of the most challenging problems. In most instances, the poor bone density of the region is compromised by sinus pneumatization, causing a lack of sufficient height for endosteous implants of adequate length for support of occlusal loads. Clinical studies of implant survival in the posterior maxilla have been unsatisfactory, with fail rates of 35% or higher for short implants (Branemark et al., 1984)

Fortunately, sinus elevation and subantral augmentation techniques, first introduced by Boyne and James (1980), Tatum (1986) and later modified by Wood and Moore (1988), have allowed increasingly more predictable use of implants in the posterior maxilla. In fact, the sinus graft technique has become one of the most common methods for increasing bone height in this area. Most of the clinician reports are in agreement as to the surgical technique but significant disagreement is found relative to the graft material to be used.

Autogenous bone has been documented as the gold standard for most grafting techniques, including the sinus graft. Both particular and block grafts from the iliac crest have shown excellent survival after implant loading and in function. Unfortunately, obtainment of bone from the iliac crest is costly and is associated with considerable morbidity. Moreover, approximately 8% of iliac crest grafts result in major complication such as infection, blood loss, hematoma, nerve injury, short and long-term pain, and functional deficits. Even if the surgery is limited to the oral cavity, the harvesting of intraoral bone adds to surgical time postoperative morbidity. Hence, the need in developing an allograft, alloplast or xenograft substitute is widely recognized.

A wide variety of materials have been used to generate bone on the sinus floor, including both block and particular autogenous bone, freeze-dried demineralized bone, freeze-dried bone, xenograft and resorbable and nonresorbable alloplasts (e.g., hydroxyapatite (hereinafter, HA), bioactive glass). These materials have been used alone or in combination (Gombotz et al., 1994; Sumner et al., 1995; Moxham et al., 1996; Ripamonti et al., 1996).

It is critical to realize that the success of sinus graft procedure is not only defined by histologic quantification of the bone generated by the graft, but more importantly by quantification of the bone at the dental implant interface.

Basic bone biology shows different types of bone healing in grafted areas, including osteoinduction and osteoconduction. The principle of osteoinduction is facilitated by osteogenic substances that induce progenitor cells in the surrounding bone to form new bone matter. Even though alloplasts such as HA have the same inorganic components as bone (i.e., calcium and phosphate), they lack both the mechanical properties and the physicochemical properties of autogenous bone, including osteoprogenitor cells, embryonic-stem cells and growth factors that are necessary to generate bone from within the graft. Alloplasts can only facilitate osteoconduction by acting as a scaffold on which new bone can grow.

The stromal compartment of the cavities of bone is composed of a net-like structure of interconnected mesenchymal cells. Stromal cells are closely associated with bone cortex, bone trabecules and the hemopoietic cells. The bone marrow-stromal microenvironment is a complex of cells, extracellular matrix (ECM), growth factors and cytokines that regulate osteogenesis and hemopoiesis locally throughout the life of the individual.

The role of the marrow stroma in creating the microenvironment for bone physiology and hemopoiesis lies in a specific subpopulation of the stroma cells. The stroma cells differentiate from a common stem cell to the specific lineage, each of which has a different role. Their combined function results in orchestration of a 3-D-architecture that maintains the active bone marrow within the bone.

Usually, when bone marrow cells are cultivated in vitro, the vast majority of hemopoietic cells die and the cultures contain fibroblast-like adherent cells (MSF). When the cells are plated at low density, they are primarily composed of colonies of fibroblast-like morphology. The cells forming these colonies were described as colony fibroblastic unit-fibroblast (CFU-F). These cells, in a primary culture, are heterogeneous and the various fibroblastoid colonies differentiate to distinctive MSF cell types. Their distinct properties differ markedly: they contain subpopulations as fibrobasts, endothelial, adipocytes and osteogenic cells. The MSF cells differ in their capacity to form bone and/or to support the growth of hemopoietic (both lymphoid and myeloid) cell lines.

Since the formation of new bone matter is facilitated by osteogenic substances that induce progenitor cells in the surrounding bone, a therapeutic strategy that include administering precursor stem or progenitor cells that are able to differentiate into bone cells is highly recommended. These cells are present at relatively low frequency in the marrow stroma, and their administration can stimulate the differentiation toward osteoblast lineage.

Several methods are known in the art to obtain osteoprogenitor cells. In one example, marrow stem cells are cultured in Dulbecco's modified Eagle's medium (DMEM) in the presence of 15% FCS, 2 mM L-glutamine, 50 U/ml penicillin, 50 μg/ml streptomycine, 50 μg/ml ascorbic acid, 50 nM beta-glycerophosphate, 10⁻⁷ M dexamethasone, retinoic acid or bFGF, so as to expand an osteoprogenitor cell population (Buttery et al., 2001).

Osteoprogenitor cells are characterized by their ability to form osteogenic nodules secreting Type-1 collagen and osteocalcin and for their ability to induce mineralization of the surrounding matrix (Robinson and Nevo, 2001).

A similar approach can be used for directing the differentiation of embryonic stem cells to form osteoprogenitors, as reported by Thompson et al. (1998); Amit et al. (2000); Schuldiner et al. (2000) and Kehat et al. (2001).

TGF-β is a polyfunctional regulatory growth factor that has been shown to have a role in extracellular matrix (ECM) synthesis and was shown to be effective in osteoinduction and be therapeutic agent for bone regeneration (Robey et al., 1987). Insulin-like growth factor-1 (IGF-1) (Toung et al., 1998), bone morphogenetic protein (BMP) (Lee et al., 1994; Gerhart et al., 1992; Yasko et al., 1992) and basic fibroblast growth factor (bFGF) (Tabata et al., 1998) were also shown to be important mediators of bone growth and turnover. Growth factors are however short lived in vivo and in order to increase their availability in the site of bone healing, the use of growth factors together with scaffolds has been introduced. Guanidine-extracted demineralized bone matrix (Moxham et al., 1996), polymeric or ceramic implants (Gombotz et al., 1994), bone grafts (Kenley et al., 1993) and human recombinant osteogenic protein-i (Cook et al., 1995), were shown to result in induced bone repair in these systems.

Recently, biodegradable hydrogels were shown to be a promising biomaterial matrix for growth factors release (Yamada et al., 1997; Yamamoto et al., 2000). It has been demonstrated that bFGF complexed with acid hydrogel had stimulatory effect on bone osteoinduction (Hong et al., 2000) and that TGF-β incorporated into acid gelatin hydrogel enhanced healing of rabbit skull defects (Hong et al., 2000). However, these experiments were limited to skull bone.

Dental implants and sinus augmentation prior to implantation are still characterized by low success rates.

There is thus a widely recognized need for, and it would be highly advantageous to have, a dental implant and a method of sinus augmentation with higher success rates, and a method of repairing other bone defects in the oral cavity.

### SUMMARY OF THE INVENTION

While conceiving one aspect of the present invention, it was hypothesized that sinus bone augmentation can be obtained using TGF-β, IGF-1 and other growth factors which promote osteoinduction and osteoconduction incorporated in a gelatin hydrogel scaffold. It was further hypothesized in this regard that better sinus augmentation will be obtained using a hydrogel that includes, in addition to growth factors which promote osteoinduction and osteoconduction, osteoprogenitor cells.

While conceiving another aspect of the present invention, it was hypothesized that enhancement of osteointegration of dental implants can be obtained by TGF-β and IGF-1 and other growth factors which promote osteoinduction and osteoconduction incorporated in a gelatin hydrogel scaffold placed in a hollow of the implant structure. It was further hypothesized in this respect that better osteointegration can be obtained using a hydrogel that includes, in addition to the TGF-β and IGF-1 and other growth factors which promote osteoinduction and osteoconduction, osteoprogenitor cells.

While conceiving another aspect of the present invention, it was hypothesized that the gelatin hydrogel described hereinabove could be further utilized for repairing other bone defects in the oral cavity.

While reducing the present invention to practice, it was found that the use of growth factors incorporated in gelatin hydrogel synergistically promote both osteoinduction and osteoconduction, resulting in fast generation of dental bone, resulting in sinus bone augmentation.

Thus, according to one aspect of the present invention there is provided a dental implant comprising a generally rod-like article formed with one or more hollow(s) therein and a biodegradable hydrogel containing one or more bone growth-promoting agent(s) in the hollow(s).

According to another aspect of the present invention there is provided a method of implanting a dental implant, the method comprising providing a dental implant that comprises a generally rod-like article formed with one or more hollow(s) therein and including a biodegradable hydrogel containing one or more bone growth-promoting agent(s) in the hollow(s) and implanting the dental implant in a bore, pre-prepared in a jaw bone of a subject in need thereof.

According to further features in preferred embodiments of the invention described below, the jaw bone is a mandible and/or a maxilla.

According to yet another aspect of the present invention there is provided a method of augmenting a sinus bone of a subject in need thereof, the method comprising placing a biodegradable hydrogel containing one or more bone growth-promoting agent(s) in the sinus cavity.

According to further features in preferred embodiments of the invention described below, placing the biodegradable hydrogel containing one or more bone growth-promoting agent(s) in the sinus cavity is by an injection.

According to still further features in the described preferred embodiments the injection is through the sinus.

According to still further features in the described preferred embodiments placing the biodegradable hydrogel containing one or more bone growth-promoting agent(s) in the sinus cavity is performed using a lateral trap door approach to the sinus floor.

According to still another aspect of the present invention there is provided a method of prosthetically rehabilitating an adentulism of a subject in need thereof, the method comprising augmenting a sinus bone of the subject, so as to provide an augmented sinus bone of the subject, providing a dental implant that comprises a generally rod-like article formed with one or more hollow(s) therein and including a biodegradable hydrogel containing one or more bone growth-promoting agent(s) in the hollow, implanting the dental implant in a bore, pre-prepared in a mandible of the subject and implanting the dental implant in the augmented sinus bone.

According to further features in preferred embodiments of the invention described below, augmenting the sinus bone is effected by the method described herein.

According to an additional aspect of the present invention there is provided a method of repairing a bone defect in an oral cavity of a subject in need thereof, the method comprising filling the bone defect with a biodegradable hydrogel containing one or more bone growth-promoting agent(s).

According to further features in preferred embodiments of the invention described below, the bone defect is selected from the group consisting of a periodontal defect, a teeth extraction, a jaw cyst, an alveolar cleft, a cleft palate and a cleft lip syndrome. According to still further features in the described preferred embodiments the rod-like article has facets.

According to still further features in the described preferred embodiments the rod-like article is formed with a mechanism for engaging a load.

According to still further features in the described preferred embodiments the one or more hollow(s) traverse the rod-like article generally perpendicularly to a longitudinal axis thereof.

According to still further features in the described preferred embodiments the one or more hollow(s) are positioned in an apical third or in a medial third of the rod-like article.

According to still further features in the described preferred embodiments the one or more hollow(s) traverse the rod-like article from a first side wall thereof to a second side wall thereof, forming a tunnel with two openings for osteointegration.

According to still further features in the described preferred embodiments the one or more hollow(s) include a tunnel.

According to still further features in the described preferred embodiments the one or more hollow(s) include one or more groove(s) formed at a side wall.

According to still further features in the described preferred embodiments the biodegradable hydrogel further containing osteoprogenitor cells.

According to still further features in the described preferred embodiments the osteoprogenitor cells comprise embryonic stem cells.

According to still further features in the described preferred embodiments the biodegradable hydrogel comprises a cross-linked polymer.

According to still further features in the described preferred embodiments the cross-linked polymer comprises an acidic protein polymer.

According to still further features in the described preferred embodiments the protein polymer is an acidic gelatin.

According to still further features in the described preferred embodiments the hydrogel biodegrades within a period ranging between 2 weeks and 8 weeks.

According to still further features in the described preferred embodiments one or more bone growth-promoting agent(s) is one or more cell(s) type expressing and secreting one or more bone growth promoting agent(s).

According to still further features in the described preferred embodiments one or more bone growth-promoting agent(s) is selected from the group consisting of an insulin-like growth factor-1 (IGF-1), a transforming growth factor-β (TGF-β), a basic fibroblast growth factor (bFGF), a bone morphogenic protein (BMP), a cartilage-inducing factor-A, a cartilage-inducing factor-B, an osteoid-inducing factor, a collagen growth factor and osteogenin.

According to still further features in the described preferred embodiments the biodegradable hydrogel further containing one or more drug(s).

According to still further features in the described preferred embodiments the drug(s) are selected from the group consisting of an antibiotic agent, a vitamin and an anti-inflammatory agent.

According to still further features in the described preferred embodiments the antibiotic is selected from the group consisting of an aminoglycoside, a penicillin, a cephalosporin, a semi-synthetic penicillin and a quinoline.

The present invention successfully addresses the shortcomings of the presently known configurations by providing a novel and advantageous dental implant, a method of successfully augmenting a sinus bone prior to an implantation of a dental implant, a method of prosthetically rehabilitating an adentulism which combines both the dental implant and the sinus augmentation of the present invention and a method of repairing a bone defect in the oral cavity.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of a hydrogel-containing dental implant according to a preferred embodiment of the present invention;

FIG. 2 are cross-sectional illustrations of hydrogel-containing dental implants according to preferred embodiments of the present invention, where the dental implant is formed with: a traversing tunnel (FIG. 2a), a T-shaped tunnel (FIG. 2b), side grooves (FIG. 2c) and apical grooves and side grooves (FIG. 2d); and

FIG. 3 is a microscope image demonstrating the histological 10 appearance of a sinus augmented with hydrogel particles containing TGF-β and IGF-1 , obtained 6 weeks post treatment.

### DESCRIPTION OF THE PREFERRED EMBODIMENTS

The present invention is of a three-dimensional (3-D) biodegradable hydrogel that is incorporated with bone growth-promoting agents and/or osteoprogenitor cells and of a dental implant containing same, which can be used in oral and dental surgeries. Specifically, the biodegradable hydrogel can be used according to the present invention to (i) promote osteoinduction and osteoconduction and hence can be used to promote osteointegration of a dental implant containing same, following a dental implantation procedure; (ii) provide for sinus augmentation prior to a dental implantation procedure; (iii) be used in an oral prosthetic rehabilitation that combines both procedures and (iv) be used in repairing other bone defects in the oral cavity.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Osteointegration of a dental implant is a major key for the success of dental prosthetic implantation. The prior art teaches biodegradable hydrogels loaded (impregnated) with growth factors, which promote osteoinduction when used as scaffolds for repairing defects in skull bones. However, such biodegradable hydrogels have never been used to promote osteoinduction and osteoconduction of dental bones and/or osteointegration of dental implants.

While reducing the present invention to practice, as is further detailed and exemplified in the Examples section that follows, it was found that the use of growth factors incorporated in gelatin hydrogel synergistically promote both osteoinduction and osteoconduction, resulting in fast generation of dental bone, resulting in sinus bone augmentation and/or osteointegration of a novel dental implant.

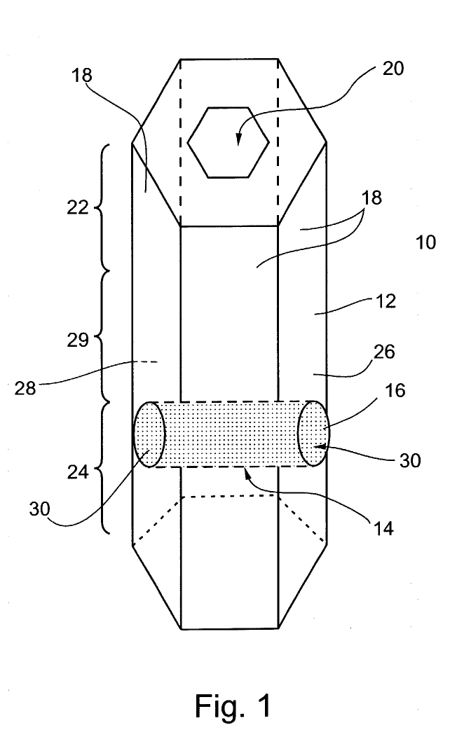

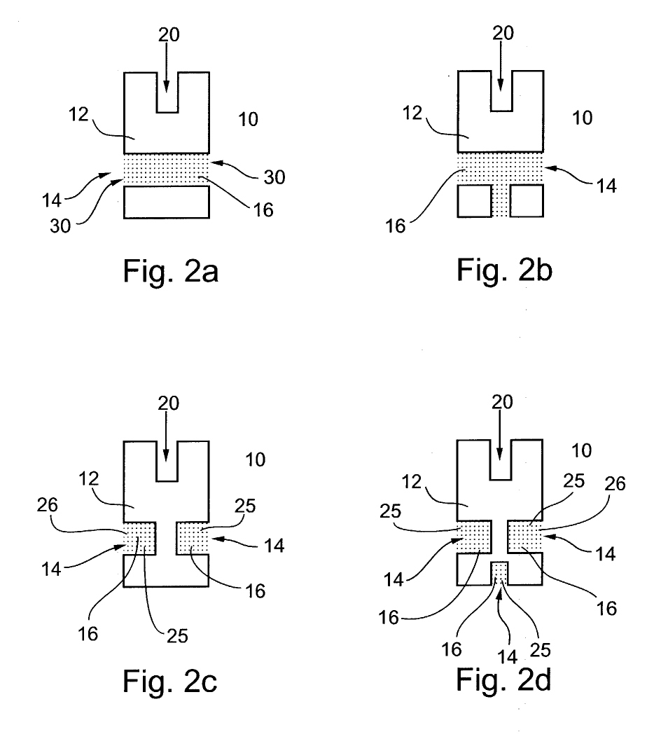

Reference is now made to the drawings. As shown in FIGS. 1-2d, according to one aspect of the present invention, there is provided a dental implant 10 that comprises a generally rod-like article 12 formed with one or more hollow(s) 14 therein and a biodegradable hydrogel 16 containing one or more bone growth-promoting agent(s) in the hollow(s) 14.

As used herein, the phrase “dental implant” includes an element that is implanted in a jaw bone, onto which a load, as this term is defined hereinafter, is attachable at a later operational stage, following implant stabilization. A dental implant has a generally rod-like shape of sufficient length so as to allow its implantation into the jaw bone while leaving a portion thereof extending into the mouth cavity, which exposed portion is used for engaging a load.

As used herein, the term “load” includes a transmucosal element shaped generally as a tooth, which is attached onto a dental implant at the second stage of the dental implantation procedure. The load is typically attached to a dental implant about 3-6 months post implantation.

According to a preferred embodiment of the present invention, as specifically shown in FIG. 1, rod-like article 12 of implant 10 has side facets 18 which serve for limiting a rotational displacement of the implant post implantation, and/or rotational displacement of the load post engagement. It will however be appreciated that the faceted rod is not a crucial feature of the implant of the present invention, as other engaging and securing means can be used instead.

As is further shown in FIG. 1, according to another preferred embodiment of the present invention rod-like article 10 is formed with a mechanism for engaging a load 20. This mechanism includes, for example, a faceted or spherical bore, into which an engaging portion of the load is secured. As is illustrated, mechanism 20 is preferably located at a topical third 22 of dental implant 10, which portion 22 remains extending into the mouth cavity and exposed following implantation of implant 10 in a jaw bone.

Dental implant 10 of the present invention is formed with one or more hollow(s) 14, filled with a biodegradable hydrogel 16, as is further detailed hereinbelow. As is shown in FIGS. 1-2a, hollows 14 are preferably positioned at an apical third 24 of implant 10, so as to facilitate osteointegration of the implant into the jaw bone. However, hollows 14 can optionally be positioned at a medial third 29 of implant 10. Further preferazzzbly, hollow(s) 14 preferably traverse rod-like article 12 perpendicularly to a longitudinal axis thereof, so as to provide for structural rigidity and stability post osteointegration. Further preferably, as is shown in FIGS. 1 and 2a, the hollow traverses the rod-like article from a first side wall 26 to a second, opposing, side wall thereof 28, hence forming a tunnel with two openings 30.

As is shown in FIGS. 2b-d, according to preferred embodiments of the present invention, rod-like article 12 of implant 10 can optionally be formed with a hollow in the form of T-shaped tunnel, (FIG. 2b), hence having three openings. As is further shown in FIG. 2, the hollow(s) can further include one or more groove(s) 25, e.g., circumferencial indentations 26, circumferencing article 12. Grooves 25 can be formed at one or more side wall(s) 18 of rod-like article 10 (FIG. 2c) or as side and apical grooves (FIG. 2d).

As described hereinabove, and is further illustrated in FIGS. 1 and 2a-d, hollow(s) 14 formed in rod-like article 12 of implant 10 of the present invention are filled with a biodegradable hydrogel that contains bone growth-promoting agent(s).

The terms “bone growth-promoting agent” and “growth factor” are used herein interchangeably.

The use of a biodegradable hydrogel is highly advantageous with respect to the present invention since the biodegradation process facilitates the release of biologically active agents, such as growth factors, cells, proteins, antibiotics or vitamins embedded therein and which are described in greater detail below. The hydrogel is known to biodegrade gradually under the effect of enzymes such as metalloproteinases and endopeptidases.

Preferably, the biodegradable hydrogel according to the present invention includes a cross-linked polymer, which enables the impregnation of biologically active agents within its pores. Further preferably, the cross-linked polymer is acidic protein such as, but not limited to, an acidic gelatin.

The biodegradable hydrogel of the present invention preferably includes charged or polar groups. Such groups, which are preferably negatively charged, enable the binding of positively charged substances such as growth factors. In addition, the negatively charged hydrogel creates an acidic, electronegative environment, which is inductive and conducive to osteogenesis.

The biodegradable hydrogel of the present invention is preferably loaded with growth factors such as, but not limited to, insulin-like growth factor-1 (IGF-1), transforming growth factor-β (TGF-β), basic fibroblast growth factor (bFGF), bone morphogenic proteins (BMPs) such as, for example, BMP-2 or BMP-7, cartilage-inducing factor-A, cartilage-inducing factor-B, osteoid-inducing factor, collagen growth factor and osteogenin.

In general, TGF plays a central role in regulating tissue healing by affecting cell proliferation, gene expression and matrix protein synthesis, BMP initiates gene expression which leads to cell replication, and BDGF is an agent that increases activity of already active genes in order to accelerate the rate of cellular replication. All the above-described growth factors may be isolated from a natural source (e.g., mammalian tissue) or they may be produced as recombinant peptides.

The bone growth-promoting agents, according to a preferred embodiment of the present invention, further include one or more cell(s) type expressing and secreting one or more bone growth promoting agents as described hereinabove. Such cells are preferably of an autological source.

The phrase “cells type expressing and secreting growth factors” includes cells that produce growth factors and induce their translocation from a cytoplasmic location to a non-cytoplasmic location. Such cells include cells that naturally express and secrete the growth factors or cells which are genetically modified to express and secrete the growth factors. Such cells are well known in the art.

The incorporation of such cells in the biodegradable hydrogel provides for effective and continuous release of growth factors, which serve to promote osteointegration of the dental implant of the present invention.

According to another preferred embodiment of the present invention, the biodegradable hydrogel further contains osteoprogenitor cells.

The phrase “osteoprogenitor cells” includes an osteogenic subpopulation of the marrow stromal cells, characterized as bone forming cells. The osteoprogenitor cells, according to the present invention, include bone forming cells per se and/or embryonic stem cells that form osteoprogenitor cells. The osteoprogenitor cells can be isolated using known procedures, as described hereinabove in the Background section or in Buttery et al. (2001), Thompson et al. (1998), Amit et al. (2000), Schuldiner et al. (2000) and Kehat et al. (2001). Such cells are preferably of an autological source and include, for example, human embryonic stem cells, murine or human osteoprogenitor cells, murine or human osteoprogenitor marrow-derived cells, murine or human osteoprogenitor embryonic-derived cells and murine or human embryonic cells. These cells can further serve as cells secreting growth factors, as described by Robinson and Nevo (2001), which are defined hereinabove.

The incorporation of osteoprogenitor cells in the biodegradable hydrogel, in addition to the growth factors, further promotes osteoinduction and hence results in improved and faster osteointegration of the dental implant of the present invention.

According to a preferred embodiment of the present invention, the biodegradable hydrogel biodegrades within a period that ranges between 2 weeks and 8 weeks, preferably between 2 weeks and 4 weeks and more preferably within a period of about 2 weeks.

The rate of biodegradation of the growth-factors/cells containing hydrogel results in controlled release of the growth factors and other bioactive agents and is an important feature of the present invention. If the hydrogel degrades too fast it does not retain the growth factors, thus allowing ingrowth of soft tissue and does not induce bone regeneration. Hydrogel that degrades too slowly could physically impede the formation of new bone. On the other hand, a hydrogel that degrades too slowly could physically impede the formation of a new bone.

The prior art discloses studies that utilized biodegradable hydrogels containing growth factors such as TGF-β (Yamamoto et al., 2000) and bFGF (Tabata et al., 1999). These studies demonstrated that tissue response to growth factors released from such hydrogels was first detected eight weeks post surgery (Lee et al., 1994).

However, as is further detailed in the Examples section which follows, the hydrogel of the present invention was found to biodegrade within two weeks, and thus was found to serve as a slow-release device of the growth factors, osteoprogenitor cells and other bioactive agents loaded therein.

As is further detailed in the Examples section which follows, the use of the hydrogels of the present invention produces responses as early as four to six weeks following surgery thus considerably shortening the response time as compared to the prior art. A newly formed bone was observed in some cases only after two weeks and appeared to be spongy, indicating an early stage of extensive bone formation that was accompanied at later stages.

It will be appreciated that this feature of the present invention is extremely important since it provides for acceleration of osteointegration of the dental implant of the present invention. It will be appreciated that in clinical situation, enhanced osteointegration and bone healing could lead to improved results of surgical procedures (Schmitz et al., 1998; Sherris et al., 1998; Bosch et al., 1996).

The biodegradable hydrogel of the present invention can further include, in addition to the bone growth-promoting agents and osteoprogenitor cells that promote osteointegration, one or more drug(s) such as, but not limited to, a vitamin, an antibiotic, an anti-inflammatory agent and the like, which can be loaded into the hydrogel matrix.

Examples of suitable antibiotic drugs which can be utilized with the present invention include, for example, antibiotics from the aminoglycoside, penicillin, cephalosporin, semi-synthetic penicillins, and quinoline classes.

Preferably, the present invention utilizes an antibiotic or a combination of antibiotics which cover a wide range of bacterial infections typical of bone or surrounding tissue.

Vitamins such as, for example, vitamin D, ergocalciferol (vitamin D₂), cholecalciferol (vitamin D₃) and their biologically active metabolites and precursors can be utilized by the present invention.

Anti-inflammatory agents may be used in the present invention to treat or prevent inflammation and pain in the treated and surrounding area following treatment. The preferred anti-inflammatory agents are without limitation, indomethacin, etodolac, diclofenac, ibuprofen, naproxen and the like.

Other drugs, which may be beneficial to the present invention include amino acids, peptides, co-factors for protein synthesis anti-tumor agent, immunosuppressants and the like.

The preparation, sterilization and loading, with bioactive agents, of the hydrogel of the present invention are described in detail in the Examples section below.

As the biodegradable hydrogel of the present invention was found to efficiently promote osteoinduction and osteoconduction, its incorporation in the dental implant of the present invention, as described hereinabove, is highly advantageous, since it efficiently promotes osteointegration of the implant.

Thus, according to another aspect of the present invention, there is provided a method of implanting a dental implant. The method is materialized by providing the dental implant of the present invention, which comprises a rod-like article formed with a hollow that is filled with the biodegradable hydrogel, as described hereinabove, and implanting the dental implant in a bore, pre-prepared in a jaw bone of a subject in need thereof.

The method of implanting the dental implant of the present invention can be performed in both jaw bones of a subject: the mandible, i.e., the lower jaw bone, and the maxilla, i.e., the upper jaw bone.

As is described and exemplified in U.S. patent application Ser. No. 09/713,037, from which priority is claimed and which is incorporated herein by reference, various bone defects are repaired by filling the defect with a biodegradable hydrogel scaffold containing bone growth promoting agents. The method of repairing bone defects, as is disclosed in U.S. patent application Ser. No. 09/713,037 resulted in accelerated formation of new bone around a fixation device. The biodegradable hydrogel described therein achieved long term retaining of the growth factors that by being locally released had effect on recruitment of osteogenic cells, leading to an overall enhanced regeneration of bone.

Based on the experimental results described in U.S. patent application Ser. No. 09/713,037, it is anticipated that implanting the dental implant of the present invention will result in the formation of new bone surrounding the dental implant and in building a bridge of bone within or through the hollow(s) of the implant, eventually replacing the growth factors-containing hydrogel.

The large contact area formed between the hydrogel in the dental implant and the implanted bone area, as a result of the hollow within the dental implant, enhances the contact area between the dental implant and the implanted bone and thus the osteointegration of the implant is strengthened. Even larger surface area can be obtained by forming hollows of larger openings, which narrow approaching the central portion of the implant.

The method of this aspect of the present invention is further advantageous since an accelerated and improved osteointegration of the dental implant provides for a shorter healing process and thus enables to perform the loading procedure that follows within a shortened time period.

The improved and accelerated osteoinduction and osteoconduction obtained using the biodegradable hydrogel described herein can be further utilized, in accordance with another aspect of the present invention for sinus augmentation prior to a dental implantation procedure in the upper jaws (posterior maxilla).

As described hereinabove, a lack of height of the sinus bone has been a major limitation in implantation procedures in the upper jaws. This limitation has been reduced using sinus elevation and subantral augmentation techniques. The presently known techniques typically use a wide variety of grafting materials to generate bone on the sinus floor, which includes autogenous bone and other materials. However, the presently used grafting materials for sinus augmentation are often unsuccessful since they lack the needed combination of both the histologic quantification of the generated bone and the quantification of the bone by the dental implant interface.

As is further shown in the Examples section that follows, while reducing the present invention to practice it was found that placing the biodegradable growth factors-containing hydrogel of the present invention in a sinus cavity resulted in sinus bone augmentation.

Thus, according to another aspect of the present invention there is provided a method of augmenting a sinus bone of a subject in need thereof. The method according to this aspect of the present invention is effected by placing the biodegradable hydrogel of the present invention described hereinabove, in a sinus cavity of the subject.

The biodegradable hydrogel can be placed in the sinus cavity by an injection. The injection of the hydrogel can be performed directly through the sinus bone, using open or closed techniques, as is well known in the art of dentistry.

According to a preferred embodiment of the present invention, the biodegradable hydrogel is placed in the sinus cavity using a lateral trap door approach to the sinus floor. This approach is well known in the art of dentistry and is performed using open or closed techniques of sinus augmentation. As is further exemplified in the Examples section that follows, the method according to this aspect of the present invention provides for the successful formation of new bone in the sinus cavity within four to six weeks post surgery. Following this time period, a reduction of the alveolar ridge in the posterior maxilla to about 5 mm was observed in jaws of dogs treated by the method of this aspect of the present invention, indicating an efficient osteoinduction. The new bone formed on the sinus floor was found to be both qualified and quantified to support a dental implant therein.

Thus, the present invention provides a dental implant that includes a biodegradable hydrogel containing bone growth-promoting agent(s) and optionally osteoprogenitor cells and other bioactive agents. The present invention further provides methods for implantation the dental implant in the jaw bones and for sinus augmentation prior to implantation of a dental implant. The methods of the present invention utilize the biodegradable hydrogel described hereinabove.

According to an additional aspect of the present invention, a combination of the above methods of the present invention, can be utilized to perform a total oral prosthetic rehabilitation.

According to this aspect of the present invention, there is provided a method of prosthetically rehabilitating an andetulism of a subject in need thereof. The method of this aspect of the present invention is effected by augmenting a sinus bone of the subject, preferably by using the method described hereinabove, providing the dental implant of the present invention as defined hereinabove and implanting the dental implant in a bore, pre-prepared in both the mandible and in the augmented sinus bone of the subject.

The successful and accelerated formation of new bone in the sinus cavity, following introduction of the biodegradable hydrogel of the present invention to the sinus, anticipates an advantageous and promising use of this hydrogel in repairing other bone defects in the oral cavity.

Thus, according to still an additional aspect of the present invention, there is provided a method of repairing a bone defect in an oral cavity of a subject in need thereof. The method of this aspect of the present invention is effected by filling the bone defect with the biodegradable hydrogel of the present invention, as described hereinabove.

According to one embodiment of this aspect of the present invention, the bone defect is a periodontal defect that requires regeneration of bone, in which case the method is effected by a periodontal surgery.

According to another embodiment of this aspect of the present invention, the bone defect is as a result of teeth extraction, which requires bone generation, including repairing and preserving the height of the bone.

According to additional embodiments of this aspect of the present invention, the method can be further utilized for augmentation of jaw cysts, which typically appear as a result of enucleation, for onlay and inlay bone graft in the jaws, used for widening and building of height of alveolar bone in the jaws and for augmentation of alveolar cleft in children suffering from cleft palate and cleft lip syndrome.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

Materials and Experimental Methods

Hydrogel preparation: Hydrogel (95% wt) was prepared by chemically cross-linking a 10% aqueous acidic gelatin (Nitta Gelatin Co. Osaka, Japan) solution with 5.0 mM glutaraldehyde at 4° C. The acidic gelatin, which was isolated from bovine bone using an alkaline process, is a 99 kDa molecule with an isoelectric point of 5.0; the gelatin was designated acidic because of its electrostatic ability. The mixed acidic gelatin and glutaraldehyde hydrogel was cast into plastic molds (3×3×3 mm). The cross-linking reaction was allowed to proceed for 24 h at 4° C. following which the cross-linked hydrogel was immersed in 50 mM glycine aqueous solution at 37° C. for 1 h to block residual aldehyde groups of glutaraldehyde. The resulting hydrogel was punched out and rinsed by double distilled water (DDW) and 100% ethanol and finally autoclaved to obtain sterilized hydrogel. The sterilized hydrogel was aseptically freeze dried (1 hour), and the water content was calculated in percent by weighing the hydrogel prior to, and following freeze drying.

Impregnation of the growth factors into the hydrogel: Impregnation of TGF-β (0.1 μg), IGF-1 (25 ng) or saline was carried out by immersing each freeze dried hydrogel in 600 μl of impregnating solution overnight at 4° C. and the swollen hydrogel was used for the various experimental groups. A similar procedure was used for impregnation of TGF-β+IGF-1 into acidic gelatin hydrogel. The hydrogel was also weighed prior to and following the swelling process.

Isolation and Integration of Osteoprogenitor Cells in the Hydrogel:

Osteoprogenitor cells are obtained according to the method described by Buttery et al. (2001) and are characterized according to the methods described by Robinson and Nevo (2001 ). Human embryonic stem cells are similarly cultured in the presence of 15% FCS, 2 mM L-glutamine, 50 U/ml penicillin, 50 μg/ml streptomycine, 50 μg/ml ascorbic acid, 50 nM β-glycerophosphate, 10⁻⁷ M dexamethasone, retinoic acid or bFGF. Nodules demonstrating the osteogenic activity, formed by the cultured cells, are tested for their ability to secrete Type-1 collagen and ostocalcin, using immunohistochemistry for demonstration of bone-specific proteins. Alizarin red and von Kossa staining and electron microscopy are used for demonstration of mineral deposits in the surrounding matrix of the nodules.

The osteoprogenitor cells and/or the embryonic stem cells are then collected and incorporated into the hydrogel, prepared as described hereinabove, using the same procedure described hereinabove for impregnation of growth factors into the hydrogel.

Preparation of a hydrogel-containing dental implant: A novel dental implant having a tunnel formed therein and filled with a hydrogel is constructed. As shown in FIG. 1, the tunnel is introduced at the upper apical third of the implant and is filled with a hydrogel loaded with growth factors, prepared as described hereinabove.

Assessment of Bone Regeneration at the Site of Dental Implantation:

1-year-old dogs are used. Animals are anaesthetized (general anesthesia) and their premolar teeth in the lower jaw are extracted. Following a 6 weeks healing period, two hydrogel-containing dental implants, described hereinabove, are placed in the posterior mandible. The tunnel in the apical third of the implants is filled with hydrogel (95% wt) containing 0.1 μg TGF-β, 25 ng IGF-1, 0.1 μg TGF-β+25 ng IGF-1 or saline.

The bone regeneration at the implantation site is assessed by soft tissue X-rays (7.5 mA; 0.5 seconds) analysis which is performed immediately after surgery and following two, four and six weeks postoperatively.

Upon termination of the experiment, animals are sacrificed and their jaws are dissected and collected for general morphology. Tissues are then fixed in 10% neutral buffered formalin (NBF), decalcified in 10% ethylene diamine tetraacetic acid (EDTA) in 0.1 M Tris-HCl, pH 7.4, for 3 weeks, embedded in Paraplast (Sherwood Medical, MO. USA), sectioned and stained with hematoxylin and eosin (H&E).

Other tissue specimens are prepared for scanning electron microscope (SEM) observation.

Assessment of sinus augmentation following treatment with growth-factor-containing hydrogel: 1-year-old dogs were used. Animals were anaesthetized (general anesthesia) and their posterior teeth in the upper jaw were extracted. After a 6 weeks healing period, reduction of the alveolar ridge in the posterior maxilla to 5 mm was performed. Using a lateral trap door approach to the sinus floor, a hydrogel (95% wt) containing 0.1 μg TGF-β, 25 ng IGF-1, 0.1 μg TGF-β+25 ng IGF-1 or saline, prepared as described hereinabove, was placed in the sinus cavity.

The sinus augmentation was assessed by soft tissue X-rays (7.5 mA; 0.5 seconds) analysis and by core biopsy taken from the sinus, which were performed after two, four and six weeks postoperatively.

Upon termination of the experiment, animals were sacrificed and their jaws were dissected and collected for general morphology. Tissues were then fixed in 10% neutral buffered formalin (NBF), decalcified in 10% ethylene diamine tetraacetic acid (EDTA) in 0.1 M Tris-HCl, pH 7.4, for 3 weeks, embedded in Paraplast (Sherwood Medical, MO. USA), sectioned and stained with hematoxylin and eosin (H&E).

Experimental Results

Sinus Augmentation Using Growth-Factor-Containing Hydrogels:

Soft tissue X-ray taken at the beginning of the experiment, on the day of operation, revealed clear radiolucency in the sinus. Radiology obtained at two weeks postoperatively revealed already the presence of an opaque material in the sinus in the TGF-β-treated group. Treatment with a growth factor-free hydrogel did not reveal such response. After four weeks, the amount of calcified material observed by X-rays increased in TGF-β and in IGF-1 groups and the most inductive in this respect appeared to be the combined treatment of TGF-β+IGF-1. By six weeks there was clear that new bone formed in the sinus in TGF-β, in IGF-1 and in TGF-β+IGF-1 groups.

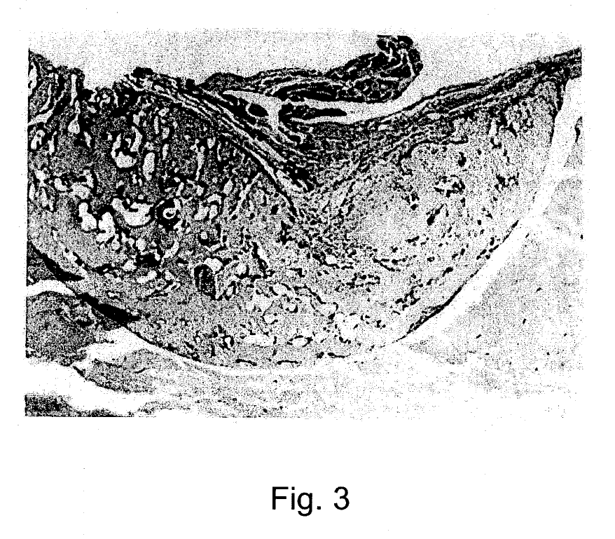

A core biopsy taken after 2 weeks revealed new ingrowth of bone trabecules between the hydrogel particles containing TGF-β, IGF-1 and TGF-β+IGF-1. No such response was observed in growth factor-free hydrogel or saline containing hydrogels. After four weeks the sinus appeared to be filled with trabecular bone (FIG. 3). By six weeks there was clear that new bone formed in the sinus in TGF-β, in IGF-1 and in TGF-β+IGF-1 groups.

These results demonstrate an enhanced and accelerated sinus augmentation, following treatment with the growth-factor-containing hydrogels of the present invention. For example, X-ray analysis, core biopsy and morphology analysis performed on TGF-β-treated animals after only two weeks postoperatively revealed, respectively, a newly formed mineralized bone, a distinct ingrowth of new bone and a partial degradation of the hydrogel. The exemplified hydrogels were found to serve as slow-release devices by slowly biodegrading in vivo and thus slow releasing the growth factors TGF-β and IGF-1. The obtained results further revealed that a combination of TGF-β and IGF-1 resulted in better response as compared with IGF-1 alone, indicating a synergistic stimulatory effect of TGF-β over IGF-1.

The presented results thus demonstrate that while the hydrogels of the present invention disappeared from the augmented sinus, mineralization of a newly formed bone occurred.

These results and the results presented in U.S. patent application Ser. No. 09/713,037 demonstrate that using the hydrogel of the present invention results in osteoinduction and osteoconduction and hence further results in osteointegration of a scaffold containing the hydrogel. It is therefore evident that implanting a dental implant containing the hydrogel as described herein would result in a successful osteointegration of the implant.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

### REFERENCES CITED

Amit, M., Carpenter, M. K., Inokuma M. S., Chiu, C- P, Harris, C. P., Watkins, M. A., Itskovitz-Eldor, J. and Thomson J. A. Clonally derived human embryonic stem cell lines maintain pluripotency and proliferative potential for prolonged periods o culture. Dev. Biol. 227-1-8, 2000.

Bosch, C., Melsen, B., Gibbons, R. Human recombinant transforming growth factor-β1 in healing of calvarial bone defects. J. Craniofac. Surg. 7:300-310;1996.

Boyne P. J., James R. A., Grafting of the maxillary sinus floor with autogenous marrow and bone. J. Oral Surg. 38: 613;1980.

Brenemark P. I., Adell R, Albrekktsson T, et al: An expremintal and clinical study of osteointegrated implants penetrating the nasal cavity and maxillary sinus. J Oral Maxillofac Surg 42:497, 1984.

Buttery, L. D. K., Bourne, S., Xynos, J. D., Wood, H., Hughes, B. D. S, Hughes, S. P. F., Episkopou, V., and Polak. Differentiation of osteoblasts and bone formation from murine embryonic stem cells. Tiss. Eng. 7: 89-99.

Cook, S. D., Wolfe, M. W., Salkeld, S. L. Effect of recombinant human osteogenic protein-1 on healing of segmental defects in non-human primates. J. Bone Jt. Surg. 77-A:734-750;1995.

Gerhart, T. N., Kirker-Head, C. A., Kriz, M. J., Holtrop, M. E., Henning, G. E., Hipp, J., Schelling, S. H., and Wang, E. Healing segmental femoral defects in sheep using recombinant human bone morphogenetic protein Clin. Orthop. Rel. Res. 293:317-326;1993.

Gombotz, W. R., Pankey, S. C., Bouchard, L. S., Stimulation of bone healing by transforming growth factor-beta 1 released from polymeric or ceramic implants. J. appl. Biomater. 5:141-150;1994.

Hong., L., Tabata, Y., Miyamoto, S., Yamamoto, M., Yamada, K., Hashimoto, N., and Ikada, Y. Bone regeneration at rabbit skull defects treated with transforming growth factor-β1 incorporated into hydrogels with different levels of biodegradability. J. Neurosurg. 92:315-325; 2000.

Kehat, I., Kenyagin-Karsenti D., Snir, M., Segev, H., Amit M., Gepstein, A., Livne, E., Binah, O., Itskovitz-Eldor J., and Gepstein, L. Human embryonic stem cells can differentiate into myocytes with structural and functional properties of cardiomyocytes. J. Cli. Invest. 108:407-414, 2001.

Kenley, R. A., Yim, K., Abrams, J. Biotechnology and bone graft substitutes. Pharm. Res. 10:1393-1401 ;1993.

Lane, M. J., Yasko, A. W., Tomin, E., Cole, B. J., Waller, S., Browne, M, Turek, T., and Gross, J. Bone marrow and recombinant human bone morphogenetic protein-2 in osseous repair. Clin. Orthop. Rel. Res. 361:216-227, 1999.

Lee, S. C., Shea, M., Battle, M. A., Kozitza, K., Ron, E., Turek, T., Schaub, R. G., and Hayes, W. C. Healing of large segmental defects in rat femurs is aided by RhBMP-2 in PLGA matrix. J. Biomed. Mat. Res. 28:1149-1156;1994.

Lind, M., Schumacher, B., Soballe, K., Keller, J., Melsen, F. and Bunger, C. Transforming growth factor-β enhances fracture healing in rabbit tibia. Acta Orthop. Sacnd. 64:553-556;1993.

Lind, M., Soren, O., Nguyen, T., Ongpipattannkul, Soballe, K. and B., Bunger, C. Transforming growth factor beta enhances fixation and bone ongrowth of ceramic coated implants. J. Orthop. Res. 14:343-350;1996.

Lind, M., Soren, O., Nguyen, T., Ongpipattannkul, B., Bunger, C. and Soballe, K. Transforming growth factor beta stimulates bone ongrowth to hydroxyapatite coated implants in dogs. Acta orthop. Scand. 67:611-616;1996.

Moxham, J. P., Kibblewhite, D. J., Dvorak, M., Perey, B., Tencer, A. F., Bruce, G., and Strong M. TGF-β1 forms functionally normal bone in a segmental sheep tibial diaphyseal defect. J. Otolaryngol. 25:388-392;1996.

Robinson, D., and Nevo, Z. Articular cartilage chondrocytes are more advantageous for generating hyaline-like cartilage than mesnchymal cells isolated from microfractures repairs. Cell Tiss. Banking. 2:23-30, 2001.

Robey, P. G., Young, M. F., Flanders, K. C., Roche, N. S., Kondaiah, P., Reddi, A. H., Termine, J. D., Sporn, M. B., Roberts, A. B., Osteoblasts synthesize and respond to transforming growth factor-type β (TGF-β) in vitro. J. Cell Biol. 105:457-463;1987.

Schmitz, J. P., and Hollinger, J. O. The critical size defect as an experimental model for craniomandibular nonunions. Clin. Orthop. Rel. Res. 205:299-308;1986.

Sherris, D., Murakami, C. S., Larrabee, Jr., W. F., and Bruce, A. G. Mandibular reconstruction with tarnsforming growth factor-β1. Laryngoscope. 108:368-372;1998.

Schulinder, M., Yanuka, O., Itskovitz-Eldor J., Melton, D. A., and Benvenisty N. Effects of eight growth factors on the differentiation of cells derived from human embryonic stem cells. PNAS 97:11307-11312, 2000.

Tabata, Y., Yamada, K., Miyamoto, S., Nagata, I., Kikuchi, H., Ayoama, I., Tamura, M. and Ikada, Y. Bone regenerationby fibroblast growth facto complexed with biodegradable hydrogels. Biomaterials 19:807-815;1998.

Tatum H. Maxillary and sinus implant reconstruction. Dent. Clin. North. EM 30:207; 1986.

Thomson, J. A., Iskovitz-Eldor J., Shapiro, S. S., Waknitz, M. A., Swiergiel , J. J., Marshall V. S., and Jones J. M. Embryonic stem cell lines derived from human blasticytes. Science 282:1145-1147, 1998.

Toung, J. S., Griffin, A., Ogle, R. C., and Lindsay, W. H. Repair of nasal defects using collagen gels containing insulin-like growth factor 1. Laryngoscope 108:1654-1658;1998.

Wood R. M., Moore D. L. Grafting of the maxillary sinus with intraoral harvested autogenous bone prior to implant placement. Int. J. Maxillofac. Implant 3:209; 1988.

Yamada, K., Tabata, Y., Yamamoto, K., Potential efficacy of basic fibroblast growth factor incorporated in biodegradable hydrogel for skull bone regeneration. J. Neurosurg. 86:871-875:1997.

Yamamoto, M., Tabata, Y., Hong, L., Miyamoto, S., Hashimoto, N., and Ikada, Y. Bone regeneration by transforming growth factor β1 released from a biodegradable hydrogel. J. Control. Rel. 64:133-142;2000.

Yamamoto, M., Tabata, Y., Ikada, Y. Ectopic bone formation induced by biodegradable hydrogels incorporating bone morphogenetic protein. J. Biomaer. Sci. Polym. Ed. 9:439-458;1998.

Yasko, A. W., Lane, J. M., Fellinger, E. J., Rosen, V., Wozney, J. M., Wang, E. The healing of segmental bone defects, induced by recombinant human bone morphogenetic protein (rhBMP-2). J.Bone Jn. Surg. 74-A:659-670; 1992.

Zambonin, G., Camerino, C., Greco, G., Patella, V.,Moretti, B., and Grano, M. Hydroxyapatite coated with hepatocyte growth factor (HGF) stimulates human osteoblasts in vitro. Bone Jt. Surg. 82-B:457-460;2000.

What is claimed is:

1. A dental implant comprising:
a generally rod-like article formed with at least one hollow therein; and
a biodegradable hydrogel containing at least one bone growth-promoting agent in said hollow.

2. The dental implant of claim 1, wherein said rod-like article has facets.

3. The dental implant of claim 1, wherein said rod-like article is formed with a mechanism for engaging a load.

4. The dental implant of claim 1, wherein said at least one hollow traverses said rod-like article generally perpendicularly to a longitudinal axis thereof.

5. The dental implant of claim 1, wherein said at least one hollow is positioned in an apical third of said rod-like article.

6. The dental implant of claim 1, wherein said at least one hollow is positioned in a medial third of said rod-like article.

7. The dental implant of claim 1, wherein said at least one hollow traverses said rod-like article from a first side wall thereof to a second side wall thereof, forming a tunnel with two openings for osteointegration.

8. The dental implant of claim 1, wherein said at least one hollow includes a tunnel.

9. The dental implant of claim 1, wherein said at least one hollow includes at least one groove formed at a side wall.

10. The dental implant of claim 1, wherein said biodegradable hydrogel further containing osteoprogenitor cells.

11. The dental implant of claim 10, wherein said osteoprogenitor cells comprise embryonic stem cells.

12. The dental implant of claim 1, wherein said biodegradable hydrogel comprises a cross-linked polymer.

13. The dental implant of claim 12, wherein said cross-linked polymer comprises an acidic protein polymer.

14. The dental implant of claim 13, wherein said protein polymer is an acidic gelatin.

15. The dental implant of claim 1, wherein said biodegradable hydrogel biodegrades within a period ranging between 2 weeks and 8 weeks.

16. The dental implant of claim 1, wherein said at least one bone growth-promoting agent is selected from the group consisting of an insulin-like growth factor-1 (IGF-1), a transforming growth factor-β (TGF-β), a basic fibroblast growth factor (bFGF), a bone morphogenic protein (BMP), a cartilage-inducing factor-A, a cartilage-inducing factor-B, an osteoid-inducing factor, a collagen growth factor and osteogenin.

17. The dental implant of claim 1, wherein said at least one bone growth-promoting agent is at least one cell type expressing and secreting at least one growth factor.

18. The dental implant of claim 17, wherein said at least one growth factor is selected from the group consisting of an insulin-like growth factor-1 (IGF-1), a transforming growth factor-β (TGF-β), a basic fibroblast growth factor (bFGF), a bone morphogenic protein (BMP), a cartilage-inducing factor-A, a cartilage-inducing factor-B, an osteoid-inducing factor, a collagen growth factor and osteogenin.

19. The dental implant of claim 1, wherein said biodegradable hydrogel further containing at least one drug.

20. The dental implant of claim 18, wherein said at least one drug is selected from the group consisting of an antibiotic agent, a vitamin and an anti-inflammatory agent.

21. The dental implant of claim 20, wherein said antibiotic is selected from the group consisting of an aminoglycoside, a penicillin, a cephalosporin, a semi-synthetic penicillin and a quinoline.

22. A method of implanting a dental implant comprising:
providing a dental implant that comprises a generally rod-like article formed with at least one hollow therein and including a biodegradable hydrogel containing at least one bone growth-promoting agent in said hollow; and
implanting said dental implant in a bore, pre-prepared in a jaw bone of a subject in need thereof.

23. The method of claim 22, wherein said jaw bone is a mandible.

24. The method of claim 22, wherein said jaw bone is a maxilla.

25. The method of claim 22, wherein said rod-like article has facets.

26. The method of claim 22, wherein said rod-like article is formed with a mechanism for engaging a load.

27. The method of claim 22, wherein said at least one hollow traverses said rod-like article generally perpendicularly to a longitudinal axis thereof.

28. The method of claim 22, wherein said at least one hollow is positioned in an apical third of said rod-like article.

29. The method of claim 22, wherein said at least one hollow is positioned in a medial third of said rod-like article.

30. The method of claim 22, wherein said at least one hollow traverses said rod-like article from a first side wall thereof to a second side wall thereof, forming a tunnel with two openings for osteointegration.

31. The method of claim 22, wherein said at least one hollow includes a tunnel.

32. The method of claim 22, wherein said at least one hollow includes at least one groove formed at a side wall.

33. The method of claim 22, wherein said biodegradable hydrogel further containing osteoprogenitor cells.

34. The method of claim 33, wherein said osteoprogenitor cells comprise embryonic stem cells.

35. The method of claim 22, wherein said biodegradable hydrogel comprises a cross-linked polymer.

36. The method implant of claim 31, wherein said cross-linked polymer comprises an acidic protein polymer.

37. The method of claim 36, wherein said protein polymer is an acidic gelatin.

38. The method of claim 22, wherein said biodegradable hydrogel biodegrades within a period ranging between 2 weeks and 8 weeks.

39. The method of claim 22, wherein said at least one bone growth-promoting agent is selected from the group consisting of an insulin-like growth factor-1 (IGF-1), a transforming growth factor-β (TGF-β), a basic fibroblast growth factor (bFGF), a bone morphogenic protein (BMP), a cartilage-inducing factor-A, a cartilage-inducing factor-B, an osteoid-inducing factor, a collagen growth factor and osteogenin.

40. The method of claim 22, wherein said at least one bone growth-promoting agent is at least one cell type expressing and secreting at least one growth factor.

41. The method of claim 40, wherein said at least one growth factor is selected from the group consisting of an insulin-like growth factor-1 (IGF-1), a transforming growth factor-β (TGF-β), a basic fibroblast growth factor (bFGF), a bone morphogenic protein (BMP), a cartilage-inducing factor-A, a cartilage-inducing factor-B, an osteoid-inducing factor, a collagen growth factor and osteogenin.

42. The method of claim 22, wherein said biodegradable hydrogel further containing at least one drug.

43. The method of claim 42, wherein said at least one drug is selected from the group consisting of an antibiotic agent, a vitamin and an anti-inflammatory agent.

44. The method of claim 43, wherein said antibiotic is selected from the group consisting of an aminoglycoside, a penicillin, a cephalosporin, a semi-synthetic penicillin and a quinoline.

45. A method of augmenting a sinus bone of a subject in need thereof, the method comprising placing a biodegradable hydrogel containing at least one bone growth-promoting agent in a sinus cavity of the subject.

46. The method of claim 45, wherein placing said biodegradable hydrogel containing said at least one bone growth-promoting agent in the sinus cavity of the subject is by an injection.

47. The method of claim 46, wherein said injection is through the sinus.

48. The method of claim 45, wherein placing said biodegradable hydrogel containing said at least one bone growth-promoting agent placed in the sinus cavity of the subject is performed using a lateral trap door approach to the sinus floor.

49. The method of claim 45, wherein said biodegradable hydrogel further containing osteoprogenitor cells.

50. The method of claim 49, wherein said osteoprogenitor cells comprise embryonic stem cells.

51. The method of claim 45, wherein said biodegradable hydrogel comprises a cross-linked polymer.

52. The method implant of claim 51, wherein said cross-linked polymer comprises an acidic protein polymer.

53. The method of claim 52, wherein said protein polymer is an acidic gelatin.

54. The method of claim 45, wherein said biodegradable hydrogel biodegrades within a period ranging between 2 weeks and 8 weeks.

55. The method of claim 45, wherein said at least one bone growth-promoting agent is selected from the group consisting of an insulin-like growth factor-1 (IGF-1), a transforming growth factor-β (TGF-β), a basic fibroblast growth factor (bFGF), a bone morphogenic protein (BMP), a cartilage-inducing factor-A, a cartilage-inducing factor-B, an osteoid-inducing factor, a collagen growth factor and osteogenin.

56. The method of claim 45, wherein said at least one bone growth-promoting agent is at least one cell type expressing and secreting at least one growth factor.

57. The method of claim 56, wherein said at least one growth factor is selected from the group consisting of an insulin-like growth factor-1 (IGF-1), a transforming growth factor-β (TGF-β), a basic fibroblast growth factor (bFGF), a bone morphogenic protein (BMP), a cartilage-inducing factor-A, a cartilage-inducing factor-B, an osteoid-inducing factor, a collagen growth factor and osteogenin.

58. The method of claim 45, wherein said biodegradable hydrogel further containing at least one drug.

59. The method of claim 58, wherein said at least one drug is selected from the group consisting of an antibiotic agent, a vitamin and an anti-inflammatory agent.

60. The method of claim 59, wherein said antibiotic is selected from the group consisting of an aminoglycoside, a penicillin, a cephalosporin, a semi-synthetic penicillin and a quinoline.

61. A method of prosthetically rehabilitating an adentulism of a subject in need thereof, the method comprising:
augmenting a sinus bone of said subject, so as to provide an augmented sinus bone of said subject;
providing a dental implant that comprises a generally rod-like article formed with at least one hollow therein and including a biodegradable hydrogel containing at least one bone growth-promoting agent in said hollow;
implanting said dental implant in a bore, pre-prepared in a mandible of said subject; and
implanting said dental implant in said augmented sinus bone.

62. The method of claim 61, wherein said augmenting said sinus bone comprises placing a biodegradable hydrogel containing at least one bone growth-promoting agent placed in a sinus cavity of the subject.

63. The method of claim 62, wherein placing said biodegradable hydrogel containing said at least one bone growth-promoting agent placed in a sinus cavity of the subject is by an injection.

64. The method of claim 63, wherein said injection is through the sinus.

65. The method of claim 62, wherein placing said biodegradable hydrogel containing said at least one bone growth-promoting agent placed in a sinus cavity of the subject is performed using a lateral trap door approach to the sinus floor.

66. The method of claim 62, wherein said biodegradable hydrogel further containing osteoprogenitor cells.

67. The method of claim 66, wherein said osteoprogenitor cells comprise embryonic stem cells.

68. The method of claim 62, wherein said biodegradable hydrogel comprises a cross-linked polymer.

69. The method of claim 68, wherein said cross-linked polymer comprises an acidic protein polymer.

70. The method of claim 69, wherein said protein polymer is an acidic gelatin.

71. The method of claim 62, wherein said biodegradable hydrogel biodegrades within a period ranging between 2 weeks and 8 weeks.

72. The method of claim 62, wherein said at least one bone growth-promoting agent is selected from the group consisting of an insulin-like growth factor-1 (IGF-1), a transforming growth factor-β (TGF-β), a basic fibroblast growth factor (bFGF), a bone morphogenic protein (BMP), a cartilage-inducing factor-A, a cartilage-inducing factor-B, an osteoid-inducing factor, a collagen growth factor and osteogenin.

73. The method of claim 62, wherein said at least one bone growth-promoting agent is at least one cell type expressing and secreting at least one growth factor.

74. The method of claim 73, wherein said at least one growth factor is selected from the group consisting of an insulin-like growth factor-1 (IGF-1), a transforming growth factor-β (TGF-β), a basic fibroblast growth factor (bFGF), a bone morphogenic protein (BMP), a cartilage-inducing factor-A, a cartilage-inducing factor-B, an osteoid-inducing factor, a collagen growth factor and osteogenin.

75. The method of claim 62, wherein said biodegradable hydrogel further containing at least one drug.

76. The method of claim 75, wherein said at least one drug is selected from the group consisting of an antibiotic agent, a vitamin and an anti-inflammatory agent.

77. The method of claim 76, wherein said antibiotic is selected from the group consisting of an aminoglycoside, a penicillin, a cephalosporin, a semi-synthetic penicillin and a quinoline.

78. The method of claim 61, wherein said rod-like article has facets.

79. The method of claim 61, wherein said rod-like article is formed with a mechanism for engaging a load.

80. The method of claim 61, wherein said at least one hollow traverses said rod-like article generally perpendicularly to a longitudinal axis thereof.

81. The method of claim 61, wherein said at least one hollow is positioned in an apical third of said rod-like article.

82. The method of claim 81, wherein said at least one hollow is positioned in a medial third of said rod-like article.

83. The method of claim 61, wherein said at least one hollow traverses said rod-like article from a first side wall thereof to a second side wall thereof, forming a tunnel with two openings for osteointegration.

84. The method of claim 61, wherein said at least one hollow includes a tunnel.

85. The method of claim 61, wherein said at least one hollow includes at least one groove formed at a side wall.

86. The method of claim 61, wherein said biodegradable hydrogel further containing osteoprogenitor cells.

87. The method of claim 86, wherein said osteoprogenitor cells comprise embryonic stem cells.

88. The method of claim 61, wherein said biodegradable hydrogel comprises a cross-linked polymer.

89. The method implant of claim 88, wherein said cross-linked polymer comprises an acidic protein polymer.

90. The method of claim 89, wherein said protein polymer is an acidic gelatin.

91. The method of claim 61, wherein said biodegradable hydrogel biodegrades within a period ranging between 2 weeks and 8 weeks.

92. The method of claim 61, wherein said at least one bone growth-promoting agent is selected from the group consisting of an insulin-like growth factor-1 (IGF-1), a transforming growth factor-β (TGF-β), a basic fibroblast growth factor (bFGF), a bone morphogenic protein (BMP), a cartilage-inducing factor-A, a cartilage-inducing factor-B, an osteoid-inducing factor, a collagen growth factor and osteogenin.

93. The method of claim 61, wherein said at least one bone growth-promoting agent is at least one cell type expressing and secreting at least one growth factor.

94. The method of claim 93, wherein said at least one growth factor is selected from the group consisting of an insulin-like growth factor-1 (IGF-1), a transforming growth factor-β (TGF-β), a basic fibroblast growth factor (bFGF), a bone morphogenic protein (BMP), a cartilage-inducing factor-A, a cartilage-inducing factor-B, an osteoid-inducing factor, a collagen growth factor and osteogenin.

95. The method of claim 61, wherein said biodegradable hydrogel further containing at least one drug.

96. The method of claim 95, wherein said at least one drug is selected from the group consisting of an antibiotic agent, a vitamin and an anti-inflammatory agent.

97. The method of claim 96, wherein said antibiotic is selected from the group consisting of an aminoglycoside, a penicillin, a cephalosporin, a semi-synthetic penicillin and a quinoline.

98. A method of repairing a bone defect in an oral cavity of a subject in need thereof, the method comprising filling said bone defect with a biodegradable hydrogel containing at least one bone growth-promoting agent.

99. The method of claim 98, wherein said bone defect is selected from the group consisting of a periodontal defect, a teeth extraction, a jaw cyst, an alveolar cleft, a cleft palate and a cleft lip syndrome.

100. The method of claim 98, wherein filling said bone defect with a biodegradable hydrogel containing at least one bone growth-promoting agent is by an injection.

101. The method of claim 98, wherein said biodegradable hydrogel further containing osteoprogenitor cells.

102. The method of claim 101, wherein said osteoprogenitor cells comprise embryonic stem cells.

103. The method of claim 98, wherein said biodegradable hydrogel comprises a cross-linked polymer.

104. The method implant of claim 103, wherein said cross-linked polymer comprises an acidic protein polymer.

105. The method of claim 104, wherein said protein polymer is an acidic gelatin.

106. The method of claim 98, wherein said biodegradable hydrogel biodegrades within a period ranging between 2 weeks and 8 weeks.

107. The method of claim 98, wherein said at least one bone growth-promoting agent is selected from the group consisting of an insulin-like growth factor-1 (IGF-1), a transforming growth factor-β (TGF-β), a basic fibroblast growth factor (bFGF), a bone morphogenic protein (BMP), a cartilage-inducing factor-A, a cartilage-inducing factor-B, an osteoid-inducing factor, a collagen growth factor and osteogenin.

108. The method of claim 98, wherein said at least one bone growth-promoting agent is at least one cell type expressing and secreting at least one growth factor.

109. The method of claim 108, wherein said at least one growth factor is selected from the group consisting of an insulin-like growth factor-1 (IGF-1), a transforming growth factor-β (TGF-β), a basic fibroblast growth factor (bFGF), a bone morphogenic protein (BMP), a cartilage-inducing factor-A, a cartilage-inducing factor-B, an osteoid-inducing factor, a collagen growth factor and osteogenin.

110. The method of claim 98, wherein said biodegradable hydrogel further containing at least one drug.

111. The method of claim 110, wherein said at least one drug is selected from the group consisting of an antibiotic agent, a vitamin and an anti-inflammatory agent.

112. The method of claim 111, wherein said antibiotic is selected from the group consisting of an aminoglycoside, a penicillin, a cephalosporin, a semi-synthetic penicillin and a quinoline.
